(19) United States
(12) Patent Application Publication
(10) Pub. No.: US 2010/0011305 A1
(43) Pub. Date: Jan. 14, 2010

(54) Dynamic Medical Data Acquisition

(76) Inventors: James Ullom, Castle Rock, CO (US); Thomas A. Neuman, Aurora, CO (US)

Correspondence Address: MARSH, FISCHMANN & BREYFOGLE LLP, 8055 East Tufts Avenue, Suite 450, Denver, CO, 80237, US

(21) Appl. No.: 12/361,249

(22) Filed: Jan. 28, 2009

Related U.S. Application Data
(63) Continuation of application No. 11/055,571, filed on Feb. 10, 2005, now abandoned.
(60) Provisional application No. 60/543,483, filed on Feb. 10, 2004.

(51) Int. Cl. G06F 3/01

(52) U.S. Cl. 715/762

(57) ABSTRACT

A medical data acquisition processing platform and method of operation for use in capturing medical data relating to one or more medical events. The processing platform including a processing system having a plurality of defined interface elements for acquiring medical data. Each of the defined interface elements provides one of data entry and selection options relative to the medical data. The processing system is further configured to provide over a network, a configurable interface to permit users to define new interface elements relating to a medical event not included in the one or more medical events. The processing platform includes an interface system to make the new interface elements available over the network to and to receive data entered by users using the defined interface elements and the new interface elements. The processing system being configured to process the data to obtain information related to the subject medical event.

### CROSS REFERENCE TO RELATED APPLICATIONS

This application is a continuation application that claims priority from U.S. patent application Ser. No. 11/055,571 entitled “Dynamic Medical Data Acquisition” filed Feb. 10, 2005, which claims priority from U.S. Provisional Patent Application Ser. No. 60/543,483 entitled “Dynamic Medical Data Acquisition”, filed on Feb. 10, 2004. The entire contents of each of which are incorporated herein by reference.

### FIELD OF THE INVENTION

The present invention relates to the field of data acquisition and management and, more particularly, to a processing platform having a plurality of interface elements for acquiring information of varying types from multiple sources and/or input points. The processing platform provides users with the ability to dynamically generate interface elements, modify existing dynamically generated interface elements, define data acquisition rules, and seamlessly integrate and distribute the same over a network environment for use by multiple users at different locations.

### BACKGROUND OF THE INVENTION

In many cases, computing systems are required to operate on externally defined data, e.g., information received in the computing system from a third party source. To acquire such data, these systems typically have a set of predefined interface elements having one or more data fields for entry of desired data. However, due to, for example, changing circumstances, unforeseen needs or an improved understanding of the data environment, the predefined element and fields may come to be viewed as insufficient. Moreover, in some cases, it is desirable to implement rules for adaptively guiding data acquisition, e.g., by prompting a user to populate additional data fields based on data already entered. It will be appreciated however, that since such data may vary on a case-by-case basis as a function of the type, source and location/environment associated with such data, it is difficult for software designers to engineer data entry interface elements capable of accommodating all data entry requirements.

For instance, in the medical industry, software packages are available for data acquisition in a variety of areas, e.g., patient admittance, pharmaceutical prescription, etc. One particular example includes software for the acquisition and management of data for poison control centers. Poison control centers utilize data acquisition software for, among other things, gathering data related to a poisoning (a potential exposure to a toxic substance or other potentially harmful exposure to a toxic or non-toxic substance), toxicity data on new drugs and/or products, etc. Poison control centers may also perform data collection for evaluation of protocols, performance of quality assurance studies, and identification of trends and concerns.

In this context, it is difficult for software designers to anticipate and account for all present and future data acquisition requirements. For instance, continuing with the example of a poison control center, the client or center itself may not be able to assist in defining data acquisition requirements for all cases, as they may be unknown at the time of software development, e.g., such as may be the case in defining an interface element for gathering data relating to the toxicity of a new drug or other product, or adding a new requirement with respect to an existing drug or other product. Since the drug product may be undeveloped at the time the software is designed it is, at best, difficult without knowledge of various information such as the type of drug, ingestion method, ingredients, etc., to define the data entry fields that will be required.

### SUMMARY OF THE INVENTION

In view of the foregoing, a broad object of the present invention is to provide a processing platform and related logic that improves acquisition of data and, in particular, acquisition of data of varying types from multiple sources and/or from multiple locations. A related object of the present invention is to provide a method by which users of the processing platform may define on a dynamic basis interface elements for acquiring such data in the processing platform. A related object of the present invention is to provide searching functionality based on the dynamically defined interface elements. A related object of the present invention is to provide a method by which users of the processing platform may define, on a dynamic basis, rules for acquiring such data in the processing platform. A further related object of the present invention is to provide seamless integration of the dynamically defined interface elements and rules into existing data acquisition software applications and distribution of the same over a network environment for use by network users. An additional object relates to implementing secure access to data based or access rules that are executed on a user-by-user basis.

In accordance with a first aspect of the present invention, a method and structure (collectively, “utility”) for capturing data using dynamically defined interface elements is provided. According to the present aspect, the utility permits users to define new interface elements for acquiring data in a data acquisition application, e.g., implemented in software, hardware and/or firmware. The application provides a plurality of defined interface elements for acquiring data of predetermined types, and allows for the definition of at least one new interface element (e.g., a new data field or data acquisition rule) by a user for acquisition of data other than the predetermined types accommodated by the plurality of defined interface elements. In the case of new data fields, such fields may define any attribute of the data such as name, date, substance symptoms, comments, etc. In the case of rules, the rules may relate to certain fields that are required or recommended to be populated, a desired sequence for data acquisition, or any other rule regarding data acquisition. Preferably, the rules are implemented so as to guide a user through a data acquisition procedure responsive to certain data inputs. (A second utility interface, separate from a data entry interface, may be utilized to define the rules/conditions under which the new data is to be acquired. This information is preferably associated with a “user control”. Such “user control” may be any non-overlapping group of one or more data fields. The portion of the interface that deals with defining the conditions is preferably metadata driven and configurable.

The data acquisition software application may be implemented on a processing platform. In this regard, the utility may involve integration of newly defined interface elements into the applications and/or making the new interface elements available over a network for use by one or more users in acquiring data. For example, the processing platform may be connected to one or more user devices directly or via a local area network. Alternatively or additionally, the processing platform may be connected via a wide area network to one or more local area networks having one or more user devices connected thereto. In this regard, newly defined interface elements may be generated on the one or more user devices and be provided to the processing platform for use by one or more users. Alternatively, the newly defined interface elements may be generated on the processing platform and provided over the network to the one or more users.

It should be noted that this utility for making new interface elements available across a network is applicable in contexts where the processing software is resident on the platform(s) receiving the new interface element information. In this regard, the process is fundamentally different from a web application where the software is run centrally on a web server, and changes to the software on the server affect all user devices (generally, no software is installed on the processing platforms except the browser). In accordance with the present invention, the software may have been installed on each processing platform. The software then receives a new capability to interpret “data”. The “data” is the resulting information (metadata) from either or both of the two utility functions described above. For example, the “data” may describe what additional fields are to be captured by the installed software, and the conditions/rules under which the data fields are to be captured (An example of a rule: Only capture this data if patient age is less than 65 years old). The “data” may be defined locally by users in control of the processing platform or defined by a central location and downloaded to the processing platform via network, or downloaded from any appropriate site. According to a further aspect of the present invention, a data acquisition application is implemented using a metadata model that allows for dynamic configuration of data acquisition fields and/or rules. The associated utility involves defining interface elements and storing metadata which holds information about the new additional fields to capture and their attributes. Examples of the attributes captured in metadata are: the type of data to be captured; whether the data is entered or selected from a pick list; is the data required to be filled in; whether there are further conditions which when met make the data required.

In accordance with a further aspect of the present invention, a utility involves providing a metadata driven (configurable) interface to permit users to define the conditions under which “actions” are performed. An example of an “action” might be 1) pop up a message or 2) require a field in the “User control” to be filled or 3) require a popup screen of additional data fields to be displayed (this screen would be dynamically built from metadata provided as described above). The screen of additional data fields may itself be considered a “User Control” allowing users to; for example specify which of the additional fields are required and the conditions under which they are required. A hierarchy of conditions and actions may therefore be built so that under appropriate circumstances a screen of additional fields pops up and then while filling in the data in the popup screen, under appropriate circumstances another screen of additional fields pops up. This process may be repeated indefinitely as required to fully define the fields necessary for a particular application. The metadata model as described above allows for the capture of the desired additional information, under the desired conditions.

According to another aspect of the present invention, a utility is provided for searching data by reference to dynamically defined interface elements such as data fields. The utility preferably involves making data, acquired by at least one newly defined interface element (e.g., defined after deployment of the associated application), searchable. Such searching may include accessing data storage using a plurality of defined interface elements and/or the new interface element. The searching functionality may be based on a metadata model and object oriented programming environment having a number of data objects configured to assume desired searching parameters defined by a user.

According to another aspect of the present invention, a utility is provided that allows for dynamically configuring a data acquisition rule set after deployment of an associated application such as a medical data acquisition application (e.g., a poison control center application). In this regard, new rules may be implemented after deployment involving, for example, new data acquisition logic. The associated methodology preferably includes providing a configurable interface to permit a user to define new rules different than a plurality of defined rules for enhancing the receipt of data in at least one of a defined interface element or a new interface element. In one example, the configurable interface employs a metadata model including a number of data objects that can be configured to assume desired attributes such that said interface can be configured to define the new rules. In this regard, the utility may utilize: 1) newly defined interface elements relating to a subject medical event not included in the one or more originally included medical events; and/or 2) new rules relating to an existing medical event. Furthermore, it will be appreciated that the utility may be utilized to modify or edit one or more of the plurality of defined interface elements.

According to a still further aspect of the present invention, a utility is provided for allowing multiple levels of secure access to a single database. The database includes multiple data entries indexed by at least two parameters. For example, the database may be a relational database including two-dimensional tables, for example, where the columns of a table represent a data field (e.g., patient name, drug or substance, age, geographic location, etc.) and the rows of the tables specify certain attributes of the data (e.g., “John,” “Pesticide X,” “21 yrs.,” “Colorado,” etc.).

In accordance with the present invention, the portion(s) of the database that may be accessed and the type of interactions that are allowed may be defined on a user dependent basis (e.g., per user or user group). For example, a security module may be used to identify a user or user group and identify particular portions of the database for secured access. These portions may be specified by the noted parameters or combinations thereof including complex combinations involving row and column limitations, e.g., for a given user group the identified portions of the database may be limited by a geographic area (e.g., a state), a list of products (e.g., of a particular company), or other criteria (e.g., non-personal information such as demographic information without identifying individual patients). These parameters may include user configurable or dynamically defined parameters as discussed above. The types of interaction may be limited to, for example, “read only,” “modify,” “use” (e.g., to specify search and reporting criteria), and “deny.”

In this manner, access to and interaction with data in a single database can be flexibly controlled to define multiple access levels for multiple users or user groups based on highly granular subject matter limitations including subject matter limitations dynamically defined after application deployment. In the context of medical information applications, such as poison control center management, this allows for: limiting government access to information within its jurisdiction or to non-personal demographic information so as to enable desired analysis while addressing privacy concerns; limiting interaction by a particular company to information concerning its products so as to address competitive concerns; and limiting certain employee access to specified information to read only while allowing supervisor access to modify such data so as to facilitate proper administration and eliminate opportunities for fraud or error. Many other examples are possible. This may be executed in a manner analogous to the above noted field/attribute based searching based on a metadata model, where security level information operates like and, in some cases, in conjunction with, search criteria (though the security level information is generally specified by a trusted party separate from the user).

### BRIEF DESCRIPTION OF THE DRAWINGS

FIG. 1 illustrates an example of a medical data acquisition-processing platform according to the present invention;

FIG. 2 illustrates an example of processing system logic for the processing platform of FIG. 1;

FIG. 3 illustrates another example of processing system logic for the processing platform of FIG. 1;

FIG. 4 illustrates another example of processing system logic for the processing platform of FIG. 1;

FIG. 5 illustrates another example of processing system logic for the processing platform of FIG. 1;

FIG. 6 illustrates a network architecture for the processing platform of FIG. 1;

FIG. 7 illustrates an example of one implementation of the processing platform of FIG. 1;

FIGS. 8A-1 through 8A-3 show user interface screens for use in implementing Dynamically Defined Fields in accordance with the present invention;

FIGS. 8B-1 through 8B-7 show user interface screens for use in implementing Dynamically Defined Rules in accordance with the present invention;

FIGS. 8C-1 through 8C-2 show user interface screens for case information entry in accordance with the present invention;

FIGS. 8D-8E show the operation of Dynamically Defined Rules in the context of case information entry in accordance with the present invention;

FIGS. 9A-1 through 9B show user interface screens for implementing certain search functionality in accordance with the present invention; and

FIGS. 10-12 show user interface screens for implementing certain security functions in accordance with the present invention.

### DETAILED DESCRIPTION

For purposes of illustration and not of limitation, various features and advantages of the present processing platform and associated operational protocols will now be described within the context of a particular application, namely, in the context of a poison control center. It is to be understood that the following description with respect to the examples given in the context of a poison control center, however, are not intended to limit the scope of the present invention. It will be apparent to one skilled in the art that the principles of the present invention can be easily applied to other areas as well, for instance, other medical applications or other applications where data of a varying sort is received from multiple sources and/or locations.

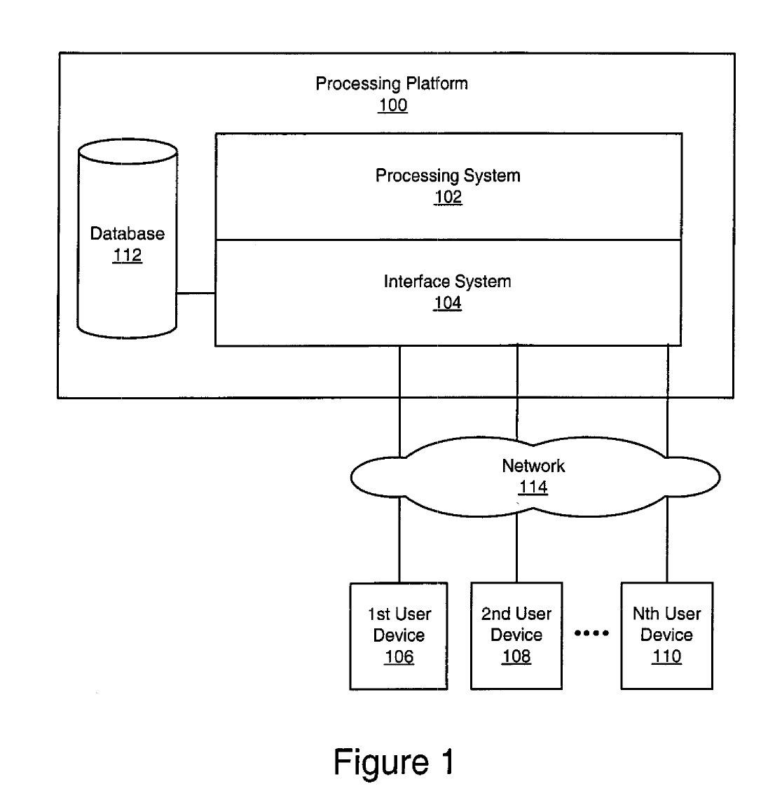

FIG. 1 depicts an example of a medical data acquisition-processing platform 100. The processing platform 100 is connected via a network 114 to a plurality of user devices, as illustrated by the first, second, and Nth user devices 106, 108, and 110 respectively. The processing platform 100 includes a database 112, a processing system 102 and an interface system 104.

The platform 100 is configured to provide a flexible dynamic data acquisition architecture to support an environment wherein data of both known and unknown nature events may be collected. For instance, in one example according to the present invention, the processing platform 100 may be utilized by poison control centers to collect data relating to a variety of medical issues. These issues may include, among other things, gathering data related to a poisoning, a potential exposure to a toxic substance, toxicity data on new drugs and/or products, etc. The processing platform 100 may also be utilized to perform data collection relating to evaluation of protocols performance of quality assurance studies and identification of trends and concerns. Accordingly, the platform 100 provides platform users, e.g., poison control center employees, with data acquisition interface elements having dynamically definable fields associated with dynamically configurable rules for acquiring data related to medical issues encountered by a poison control center.

By way of background, such medical issues are often brought to the attention of a poison control center via a call to the center from a subject patient or associated party. Accordingly, it is desirable for a poison control center employee fielding a call to collect a variety of information including, among other things, biographical information relating to the caller, e.g., name, age, etc., as well as information relating to the type of exposure, e.g., type of substance, amount, etc. In this regard, the platform 100 may be utilized to provide appropriate interface elements as a function of the type of issue encountered. These may be fixed interface elements because these fields are common and known beforehand. Additionally, supervisor users may decide that extra information needs to be captured, for example, whenever an overdose is reported. Supervisor users may define the additional fields they want captured and the conditions under which they should be captured (in our example, when the exposure is an overdose) using newly defined data fields and newly defined rules. Specifically, logic as discussed above implements certain utilities that allow for definition of new fields and new rules. Metadata is created by these utilities. Supervisor users may then release/activate these definitions to the processing platform, where they take immediate affect.

For example, in the case of an overdose, the platform 100 may provide an employee with an interface element including options for data entry related to an overdose incident. Furthermore, the platform 100 may permit the employee to access one or more different data collection interfaces as a function of the type of overdose, e.g., substance involved.

In this regard, the platform 100 may be utilized to manage and execute one or more rules relating to a data collection operation using the interface elements provided by the platform 100. For instance, continuing with the above example, such rules may be utilized to guide the data collection event to assist in the collection of the requisite data, e.g., providing pop-up text and dynamic interface elements or highlighting particular data fields, where appropriate, as function of the data being received.

An important advantage of the platform 100 is that it further provides platform users having appropriate access rights with the ability to dynamically create or generate new interface elements, e.g., data fields and rules. Furthermore, the platform 100 provides platform users having appropriate access rights with the ability to dynamically edit existing dynamically created interface elements to make the same more accommodating for specific data collection events. Advantageously, this permits the platform 100 to accommodate previously undefined or unknown data collection requirements such as, for example, in the context of a poison control center, allowing a platform user to generate a new interface element designed for collection of toxicity data on a recently developed drug, etc. Similarly, new data fields may be defined for enhanced analysis of previously recognized medical events, or the designation of required and recommended data fields for a previously recognized medical event may be altered. All of this can be implemented after application deployment in accordance with the present invention, such that a new release of the underlying code is not required to accommodate changing needs. Another important advantage of the platform 100 is that once a new interface element is generated, the new interface element may be seamlessly integrated into the existing software applications running on the platform 100 and made available over network 114 to all or a desired group of platform users. Furthermore, data collected using a new interface element in addition to an interface element originally provided in connection with the application, is fully searchable and reportable by platform users having appropriate access rights.

Another important advantage of the platform 100 is that it provides platform users with the ability to edit existing dynamically created and/or newly generated interface elements to accommodate unique conditions that may arise. For instance, in the context of a poison control center, it may be desirable to add data fields, e.g., edit an interface element, to accommodate data collection related to a localized contamination event, e.g., for instance, as in the case of a contaminated water supply.

Another important advantage of the platform 100 is that it provides users with the ability to dynamically define rules relating to a data collection operation using the interface elements provided by the platform 100. As noted herein, such rules may be utilized to guide a data collection event and assist in the collection of the requisite data, such as by providing pop-up text and interface elements as function of the data being received. In addition to user definition of such rules, the platform 100 may further permit a platform user to apply such dynamically defined rules to some or all of the interface elements, e.g., pre-existing or user generated interface elements, as a matter of choice.

The processing system 102 may be generally described as any processor or group of processors configured to manage interface elements for collecting data relating to medical events. Accordingly, the processing system 102 may be configured to manage reading and writing of data to these elements as well as storage and retrieval of collected data for network users. The processing system 102 may be further configured to facilitate dynamic generation of new interface elements and the integration of the same across a network environment. Furthermore, the processing system 102 may be configured to facilitate the dynamic generation of rules relating to data collection using the existing and newly generated interface elements, as well as storage and retrieval of associated data according to the defined rules.

The user devices 106, 108 and 110 may include workstations or computers having data input/output means such as monitors, keyboards, etc., and interface hardware for communicating with the platform 100 over the communication network 114. The communication network 114 may be a public or private communication network with some examples including, without limitation, a local area network (LAN), wide area network (WAN), or LAN connected to a WAN. According to this characterization, the interface hardware may include encryption or other security logic for ensuring the privacy of transmitted data and corresponding decryption logic. It will be appreciated that the user devices 106, 108 and 110 are utilized for the purpose of illustration and that the exact number of devices may vary according to implementation of the present principles.

The interface system 104 may be any system configured to exchange communications between the database 112, the processing platform 100, and the user devices 106, 108 and 110. As will be appreciated from the following description, software configured in accordance with the present invention may reside on the platform 100, on each of the devices 106, 108, 110, or combinatively on the platform 100 and on the devices 106, 108 and 110. In this regard, the interface system 104 may include various conventional hardware and/or software elements to implement the management and generation of interface elements for collection of data relating to medical events using the user devices 106, 108 and 110.

The database 112 may be one or more relational databases, which may be used to store a number of different data types for access and retrieval by the processing system 102. Such data may be generally characterized as metadata, system data, and real data. According to this characterization, metadata is the application of independent units for internal use by the processing system 102 and includes, for example, user defined rules data. Real data includes data collected by an interface element in relation to a medical event. System data encompasses all other data stored for use by the processing system 102, including translation defined data.

In one example of its operation, the processing platform 100 utilizes object oriented programming to permit the dynamic creation and, preferably, distribution of interface elements to other network users using a set of autonomous entities, known as objects, that work together to accomplish a desired programming result. It will be appreciated, however, that the invention could be implemented using other programming schemes such as procedural programming. An object may be a data structure and a set of operations and functions that can access that data structure. An object is a self-contained software package that combines variables and methods that operate on these variables. The variables may take data values so that an object's state is defined by the values of its variables at any point in time. Each object in an object-oriented environment provides one or more services when requested by a client. An object conceptually includes two parts; an external object interface and internal object implementation. Operations are the way of accessing an object's variables for the purpose of reading or modifying them. In an object-oriented environment, all operations for a particular object are performed through the object interface. Because outside objects have no access to the internal implementation, that internal implementation can change without affecting other aspects of the program.

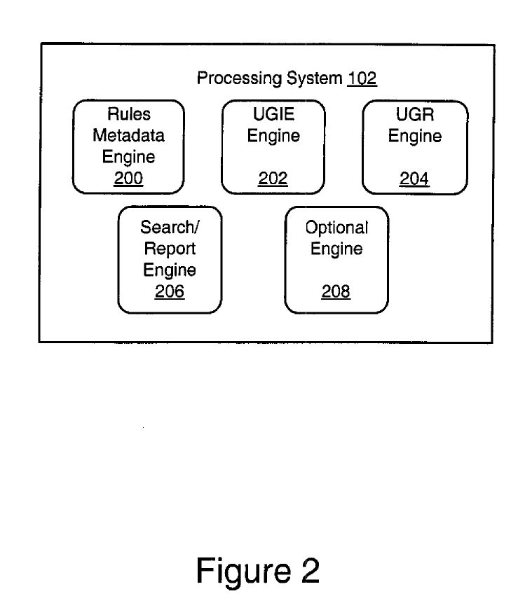

In addition to having an effect on its local state, an operation can itself cause messages to be sent to other objects, which causes invocation of further operations in the recipient objects. An object is defined via its “class” and is an “instance” of the class. A class is a software template that defines the external interface of the object by means of interface definition language (IDL) statements. The external interface is unchanging and enables the object's operations to be invoked and data to be passed to and from the object variables. The internal implementation of an object may be changed providing its external interface conforms to its class definition. Because of the continuity of the external interface, objects are readily reusable by other application programs and may be replaced by freshly written versions without affecting an application program that invokes them. FIG. 2 illustrates an example of the processing system 102. The processing system 102 may comprise a data controller engine 200, a user generated fields (UGIE) engine 202, a user generated rules engine (UGR) 204, a search/report engine 206 and an option engine 208. Collectively, the engines 200-208 perform functions for the management of medical data and the associated interface elements utilized to collect the same. In the present example, the engines 200-208 may be a number of object oriented software modules configured to manage the collection of medical data for one or more poison control centers by operating on a metadata model, e.g., generic units, that are independent of specific data. Accordingly, the processing system 102 may be constructed from one or more processors and/or integrated circuits. The processing system 102 may also include a conventional operating system that supports an object oriented programming environment. Those skilled in the art will appreciate that the processing system 102 would also include other conventional components such as a permanent main memory and a random access memory interconnected by a system bus.

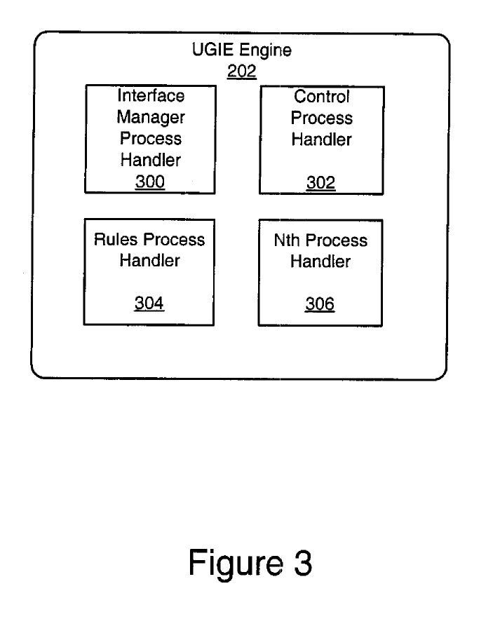

The data controller engine 200 provides the guidelines for accessing and storing data and performing computations within the processing engines 202-208, as well as providing information to a user through, for example, a graphical user interface (GUI). The employment of rules will be described in more detail below. Furthermore, as noted, metadata models are used to describe units of data, which are processed by the engines 202-208 to achieve a desired result. The metadata models may include such items as units of measure or any other quantity or description that a user desires. It will be appreciated that such metadata models may be built specific to a particular industry such as the medical industry or, more particularly, to the poison control industry It will be appreciated that the data controller engine 200 may include various processing modules for administering the various functions further described below. Referring to FIG. 3, the UGF engine 202 may include process handlers 300, 302, 304 and 306 to provide one or more services when requested by the engine 202. The process handlers 300-306 may each combine their respective data and methods that operate on the data to operate according to the following principles. For instance, according to the present example, the UGIE engine 202 may include an interface manager process handler 300, a control process handler 302, a user defined rules process handler 304 and an Nth process handler 306. The Nth process handler 306 is provided to illustrate that, as would be appreciated by those skilled in the art, additional logic may be applied during the management and generation of user defined interface elements as a matter of design choice.

The interface manager 300 may be configured, in cooperation with the data controller engine 200, to provide a GUI on a respective one of the user devices 106, 108 and 110. The GUI may allow a user to select an existing or previously defined dynamic interface element for editing. According to another option, the GUI may allow the user to enter a design mode to generate a new interface element. Upon selecting to create a new interface element, the process handler 300 may enter a design mode that provides an interface element design screen for the user. The process handler 300 may further create a corresponding data table in the database 112. In the design mode, a user may be provided with various options relating to definitional characteristics relating to the new interface element. For instance, the user may name the data table associated with the interface element. The user may enter text to be displayed in label areas of the interface element when the interface element is later selected for a data entry operation. The user may specify a type of interface element. For instance, the interface element type may be a single or multiple data entry type, the former being an interface element designed to collect data relating to a single event, e.g., an aspirin overdose. and the later being an interface element designed to collect data relating to multiple related events, e.g., such as the gathering of toxicity data for a new drug. The user may further designate a group of users to which the new interface element is to be published or provided, e.g., all poison control centers versus only a particular poison control center or, similarly, poison control centers in a particular geographic area, such as the northwest.

A user may also designate a status of the new interface element. For instance, the user may create an interface element for later use in which case an inactive status may be designated. Similarly, where a new interface element is to be made immediately available, an active status may be designated. It will be appreciated that the above noted characteristics are provided for purpose of illustration and that other characteristics may be defined in the design mode as a matter of design choice.

Upon definition of the various general characteristics, the control process handler 302 may be invoked to provide the user with the ability to build the data collection entry fields or selection options. In other words, the process handler 302 may permit the user to define and label the various data collection entry fields and/or selection options to be included in the interface element. It will be appreciated that such fields will vary on a case-by-case basis but that some examples may include, without limitation, substance type (e.g., substance number, substance description, substance generic code, substance quantity, substance formulation, etc.), routes of exposure (e.g., ingestion, inhalation, aspiration, ocular, dermal, etc.), case information (e.g., case number, center code, year code, date, follow-up-number, etc.), and/or miscellaneous information (e.g., override codes, primary center code, etc.).

The rules process handler 304 may be invoked to permit the user to define various rules relating to the actual formatting and collection of data in the defined data entry fields and/or selection options. For instance, the process handler 304 may permit the user to define rules such as a field pop-up order (e.g., if aspiration is entered as the route of exposure then provide a pop-up field for identification of an entry point such as inhalation or dermal). As another example, required or desired data fields may be highlighted or other fields may be grayed to inhibit population of those fields, based on data already entered in certain fields. In another instance, the rules may be related to a required data format type, etc., such as a date format. It will be appreciated that, as with the field definition, various rules relating to the data format and collection may be defined as a matter of design choice.

As noted above, the interface manager 300 also allows a user to select an existing interface element for definition or editing. If an existing interface element is selected, the process handlers 300-306 may be utilized to permit the user to view and modify the selected interface element as a function of the user's security and access rights. For instance, the process handlers 300-306 may be invoked to provide various options including, without limitation, an option to add new fields, an option to edit existing fields and/or text, an option to change the publication group and/or an option to change an active or inactive status.

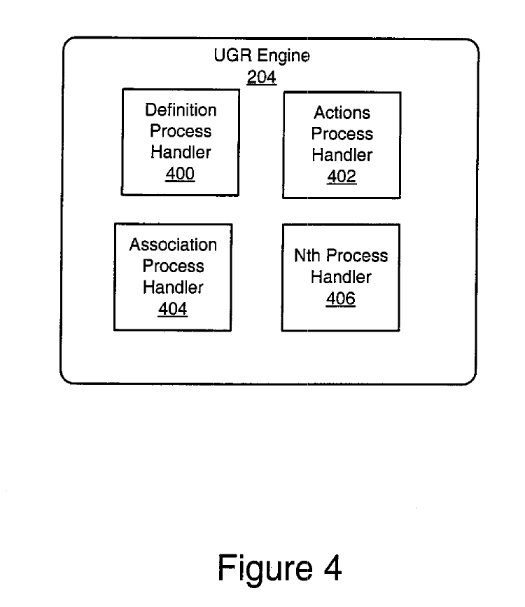

Referring also to FIG. 4, the UGR engine 204 may include various process handlers 400-406 configured to permit users to define one or more sets of rules to be utilized during a data entry event using one or more of the interface elements. In this regard, the UGR engine 204 may include a definition process handler 400, an actions process handler 402, an association process handler 404 and an Nth process handler 406. As with the UGIE engine 202, the UGR engine 204 includes an Nth process handler to apply additional logic to rule definition, as would be appreciated by those skilled in the art.

In this regard, the definition process handler 400 may be configured to provide a GUI on a respective one of the user devices 106, 108 and 110. The GUI may in turn provide the user with the option of editing an existing rule set or defining a new rule set. Upon choosing to define a new rule set, the definition process handler 400 creates a corresponding data table in the database 112 and allows the user to define various general characteristics relating to the new rule set such as a name and application criteria. For instance, the new rule set may be configured to apply its associated actions to all interface elements or a selected one or more of a class of interface elements. In another instance, the new rule set may be configured to apply its associated actions when one or more criteria are met during a data entry event using an interface element.

The actions process handler 402 is configured to allow the user to select actions from a list of previously defined actions or to define new actions to be associated with the new rule set. In the present context, an action may include any rule defined for a data collection event. For instance, in one example of an action, the user may define data fields in an interface element that require data entry prior to saving a record of the information collected. In another example of an action, the user may define data entry fields to be added to an interface element during a data collection event as a function of the data entered during the event, e.g., if X is entered then data interface fields Y and Z are further required. In another example of an action, the user may define text messages to be displayed to a user of the interface element, as well as triggers for displaying such text messages during a data entry event. In another example of an action, the user may define data fields that are required and data fields that are optional during a data entry event using an interface element.

The association process handler 404 may be configured to permit the user to associate defined or selected actions with a rule set. The association process handler 404 may further be configured to associate the rule set with one or more of the interface elements to which the rule set is to be applied as defined by the definition process handler 400.

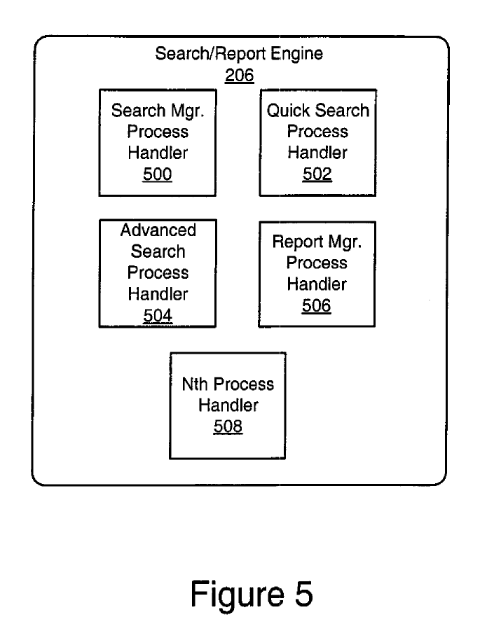

Referring to FIG. 5, the search/report engine 206 may be configured to permit users to perform data searches relating to data collected by user interface elements, whether existing or dynamically created by a system user, and run a variety of reports on the retrieved data. In particular, the search engine 206 may provide a tool for locating and retrieving metadata records based on full-text and field-limited keyword searching. Dependent on a user's security rights, such searches may be performed at a local area network level, a wide area network level and/or on archive databases. For purposes of illustration, the search/report engine 206 may include the following exemplary process handlers; a search manager process handler 500, quick search process handler 502, an advanced search process handler 504, a report manager 506, and an Nth process handler 508. As with the UGIE engine 202 and UGR engine 204, the search/report engine 206 includes the Nth process handler 508 to apply additional logic to the search and report functionality as would be appreciated by those skilled in the art.

The search manager process handler 500 may provide functionality for the management and control of searching and search criteria. For instance, the search manager process handler 500 may permit users to save searches for quick access, e.g., commonly used searches. The search manager process handler 500 may also permit users to manage saved searches such as permitting a user to edit and or delete a saved search. The search manager process handler 500 may also permit users to add prompts to a search such that during performance of the search the user is prompted to enter required information.

The quick search process handler 502 may be configured to permit a user to locate information using uniform data fields, e.g., data fields that are typically included in all interface elements. For instance, in the context of a poison control center, the quick search process handler 206 may permit users to select and search data fields including without limitation, case number, entry date/time, follow-up entry date/time, patient name, etc. In this regard, all fields, including fields defined after deployment of the application using the metadata model, may be searchable. In another instance, the quick search process handler 206 may permit the user to select from one or more predefined searches, which have built in search criteria. In another instance, the quick search process handler 206 may permit the user to access one or more saved searches.

The advanced search process handler 504, on the other hand, may be configured to provide additional searching functionality and flexibility for more advanced searches. Accordingly, the advanced search process handler 504 may provide functionality such as permitting a user to select from one or multiple lists of search criteria or select and deselect data fields presented in a grid format with columns running across the grid and input fields, where the user inputs the requested information running down the grid in rows. Such input fields and their related sub-fields may be clustered together in information groups containing related information or input sub-fields. Input fields with input sub-fields may include expand and contract icons so that a user is permitted to zero in on a particular information group and roll up or contract all other input sub-fields to allow easier viewing of user-selected fields. The advanced search process handler 504 may also be configured with a de-select feature that permits the user to de-select previously entered information. When information is de-selected, the information is not deleted, but rather the system prevents the information from being utilized in the current search or report. Advantageously, a user could run a search or report with information de-selected and run a subsequent search or report using the deselected information without having to delete and re-enter the information.

The advanced search process handler 504 may further permit the user to utilize operands to gather data that meets criteria other than just equal to. For instance, such operands may include without limitation, equals, greater than or equal to, less than or equal to, does not equal, greater than, and/or less than. In another instance the advanced search process handler 504 may permit the user to utilize operands such as “between,” “like” or “Null.” In this regard, the “like” operand may be utilized to find data that is similar to what is included in the search criteria. The between operand may be utilized to find data that is between two values such as for example a date range. The “Null” operand may in turn be utilized to find data fields that have no value or are blank, e.g., a data record having no telephone number.

The report manager process handler 506 may operate similar to the search manager 500 in that it provides functionality for the management and control of reporting and report criteria. The report manager process handler 506 may further invoke the search manager 500 and search process handlers 502 and 504 to access and retrieve data for generating desired reports. In this regard, the report manager 506 may permit users to define various desired report criteria using for example the operations of the advanced search process handler 504. The report manager process handler 506 may also permit users to save reports for quick access, e.g., commonly used reports. The report manager process handler 506 may also permit users to manage saved reports such as permitting a user to edit and or delete a saved report. The report manager process handler 506 may also permit users to add prompts to a report such that during definition of the report criteria a user is prompted to select and/or enter required information.

As noted, the engines 200-208 and their associated process handlers operate as a client server application. In this regard, the client or engine, when invoked, sends messages to the server objects or process handlers whose methods the engine desires to invoke. The methods are an automated version of the operations required to perform the above set forth operations. In this regard, the process handlers each include one or more objects that contain a method comprising the set of operations and functions that correspond to the described methods. In this regard, the Nth engine 208 represents that the processing system 102 could include numerous other engines and process handlers that include methods to facilitate operation of the processing system 102. The object-oriented framework of the processing system 102 flexibly couples processes defined in the process handlers together in a framework to define a process flow. Advantageously, since at run-time, a process determines the next step in the process flow from the static object structure, the present architecture only needs to be programmed once.

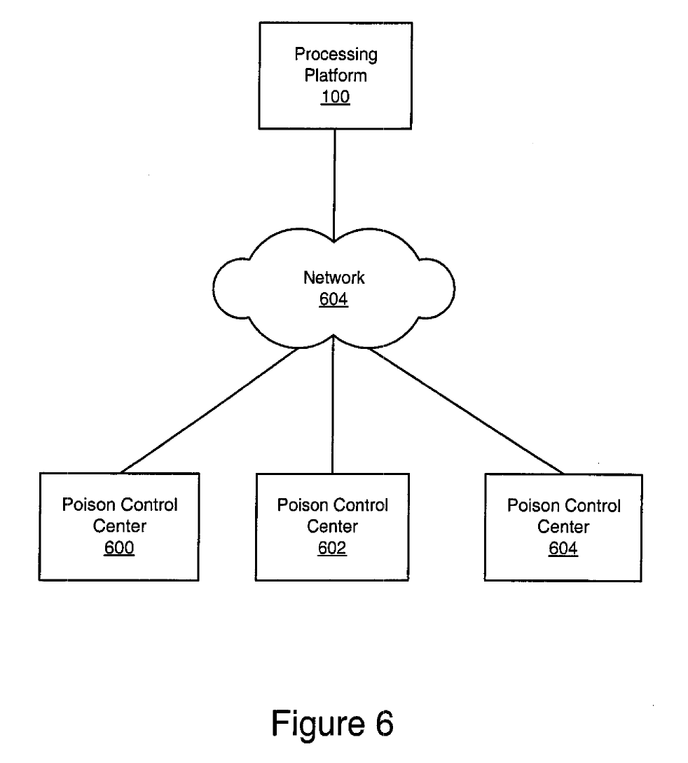

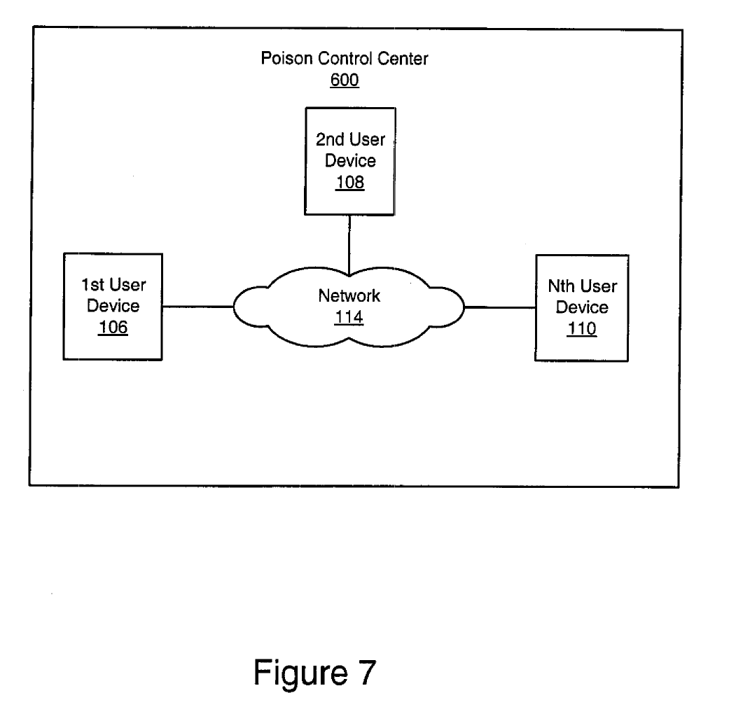

Referring to FIGS. 6 and 7, there are shown examples of a network architecture according to the present invention. As illustrated on FIG. 6 the processing platform 100 may be located at a central location, e.g., a national poison control center, and be connected via wide area network 606 to a plurality of local poison control centers throughout the country, as exemplified by poison control centers 600, 602, and 604. As illustrated on FIG. 7, the poison control centers may in turn include users devices, such as devices 106-110, connected to a local area network 606 which is in turn connected to the processing platform 100 via network 604. Advantageously, this architecture facilitates seamless distribution and integration of the user generated interface elements and user generated rule sets. In other words, users with appropriate access rights at each of the plurality of position control centers 600-604 may dynamically generate user interface elements and rules using processing logic on the processing platform 100. Such dynamically generated interface elements and rules may then be distributed by the processing platform 100 across the network 604 for use by users at each of the poison control centers 600-604. Similarly, system administrators at the central location may generate interface elements and rules, which may be distributed and used by each of the poison control centers 600-604 or desired ones of the same. In this manner, a novel capability is provided to quickly identify data acquisition needs, dynamically define associated data fields and rules, and enable appropriate data collection at multiple collection points. Thus, a coordinated response can be implemented in response to emerging needs, e.g., associated with an outbreak of a medical condition or monitoring of a widespread contamination event due to belligerents, malfeasance or otherwise.

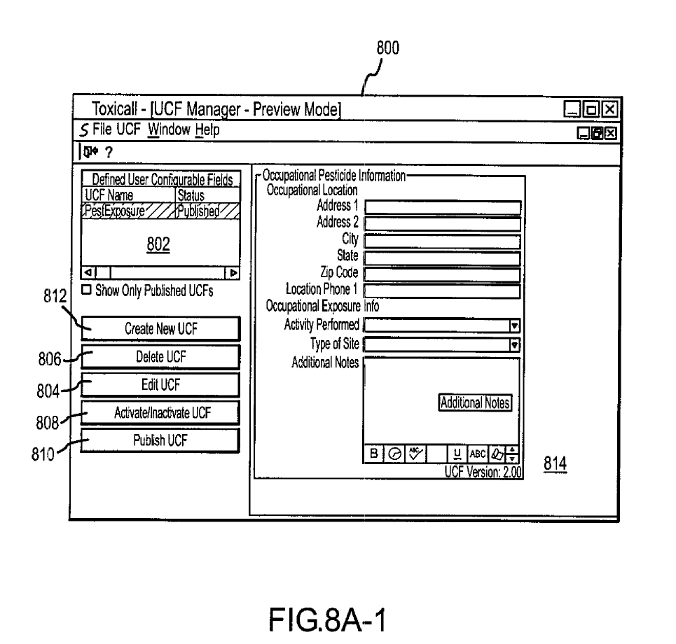

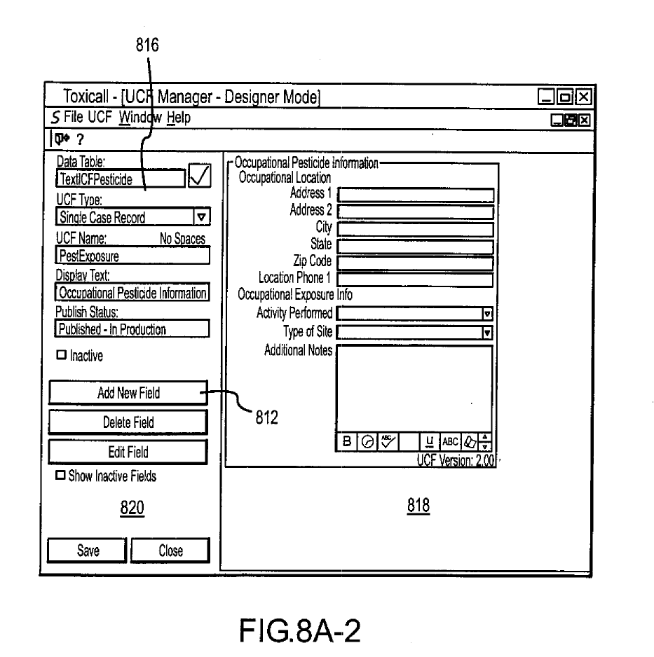

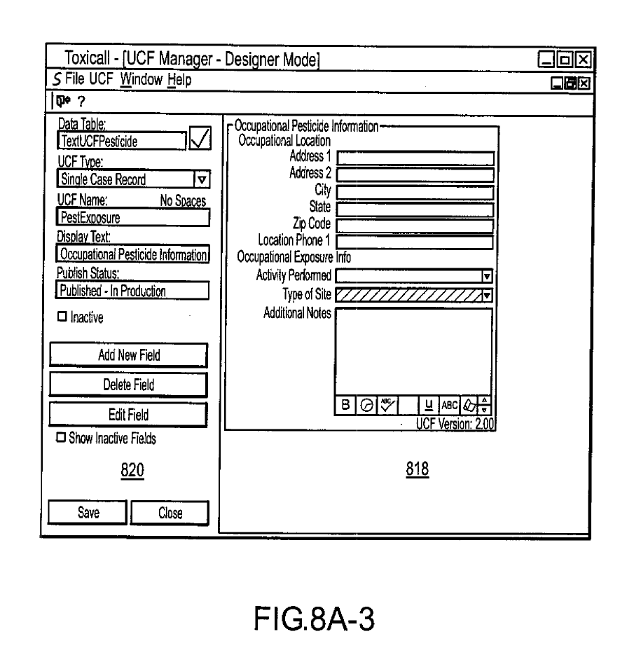

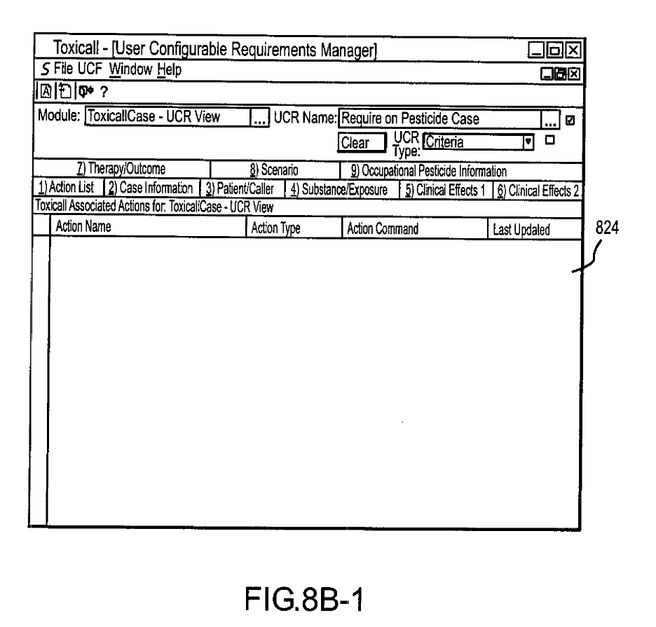

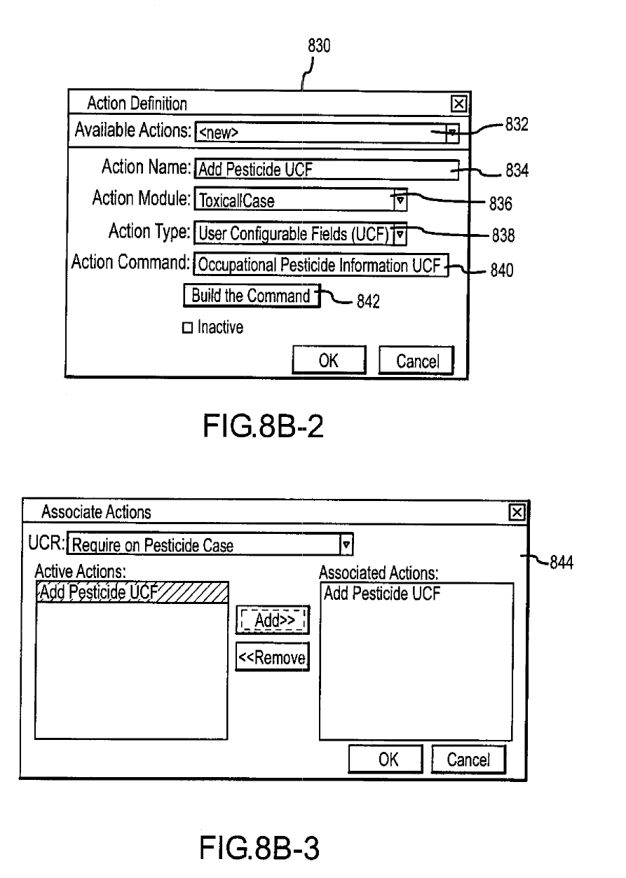

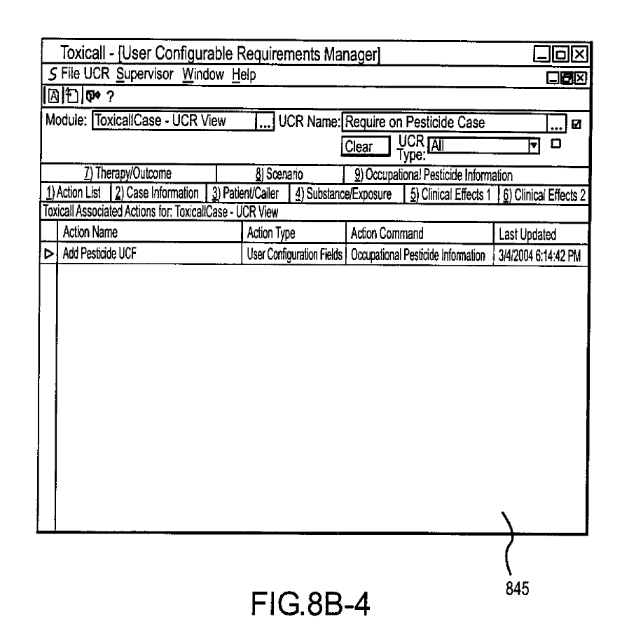

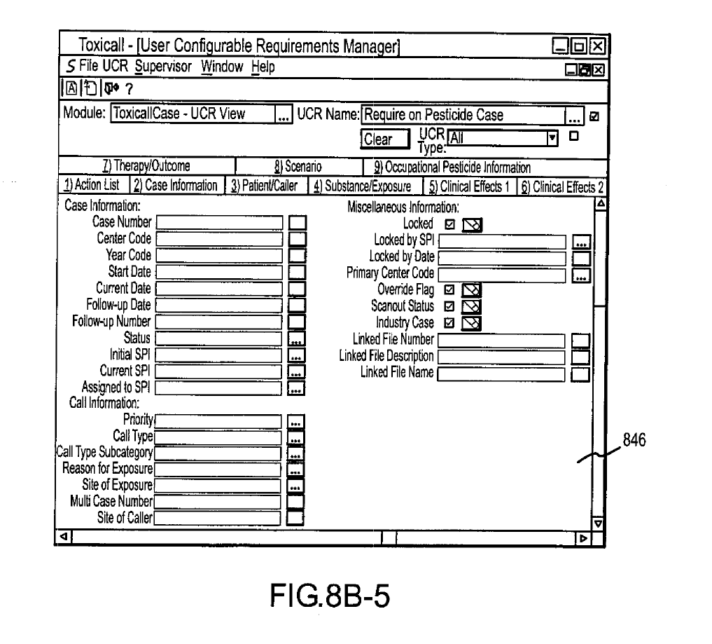

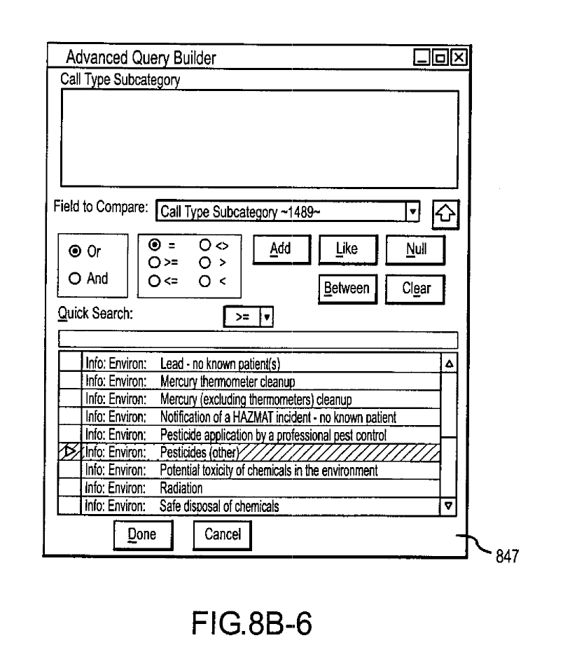

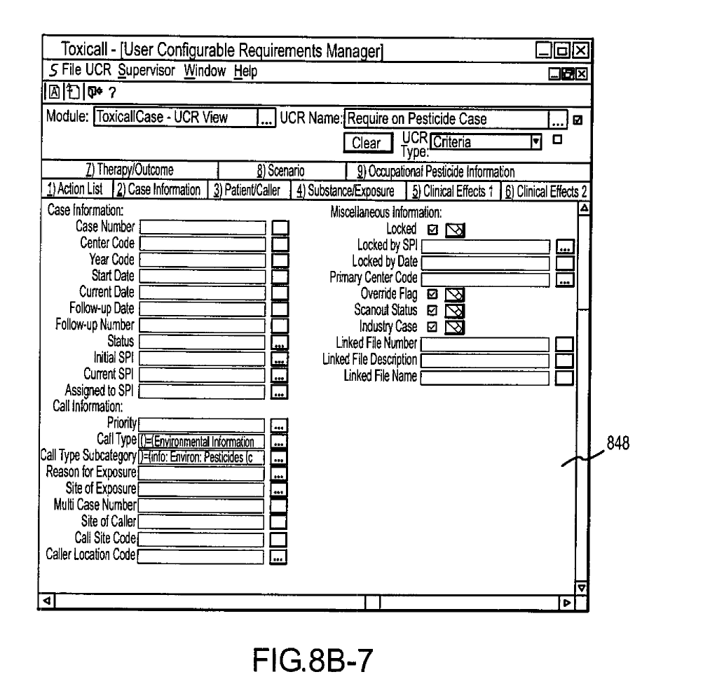

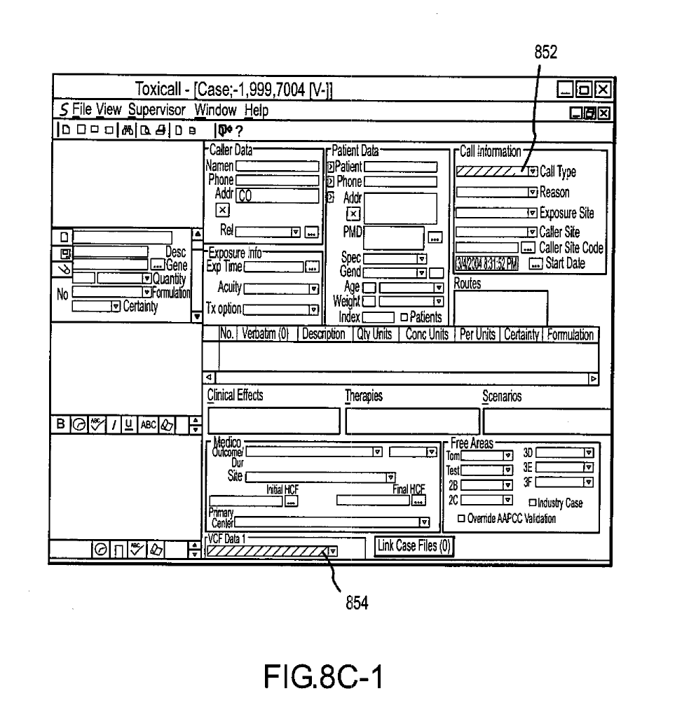

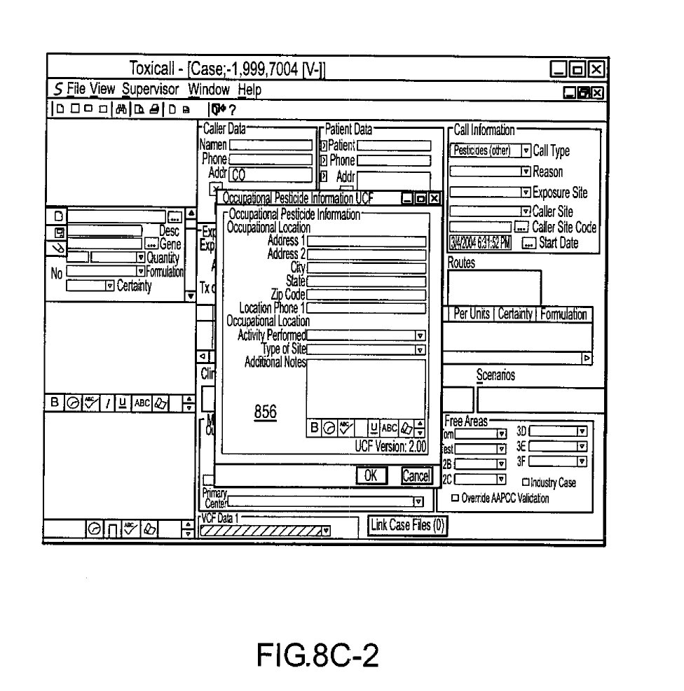

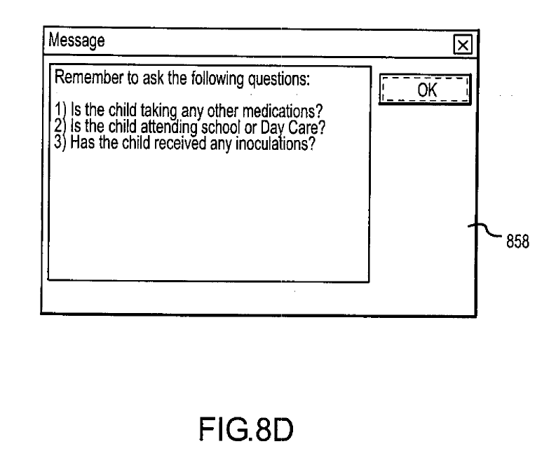

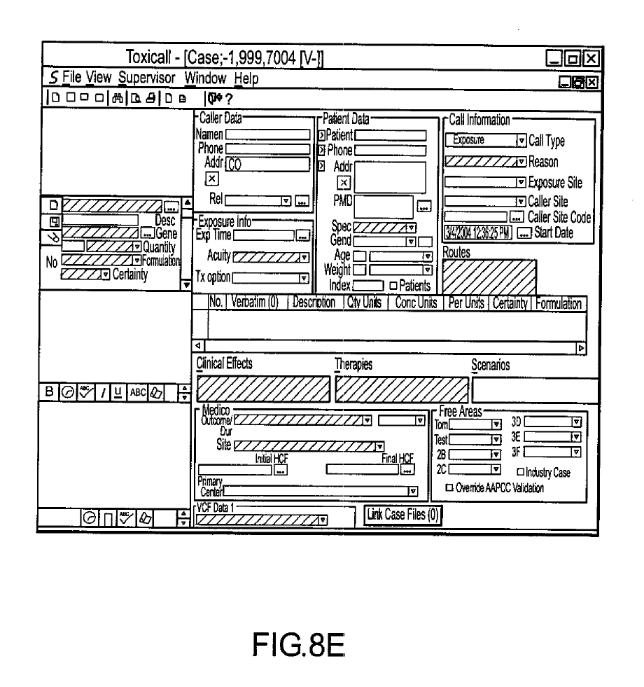

Referring to FIGS. 8A-1 through 9B, there are shown some examples of GUI screens to provide the above-described functionality to a user of the processing platform 100. Referring first to FIGS. 8A-a through 8A-3, these screens relate to implementing Dynamically Defined Fields or User Configurable Fields (“UCFs”). In particular, these screens may be associated with a UCF Manager operating in a design mode. FIG. 8A-1 provides an example of a GUI screen 800 for working with existing interface elements and/or creating new interface elements. In this regard, screen 800 allows a user to select a UCF from an area 802 for definition or editing. Upon selection or highlighting of a UCF in the area 802, the data and options associated with that UCF are shown in a preview area 814. The user is also provided with the option to edit the selected UCF via button 804, deleting the UCF via button 806, change the status of the UCF via the button 808 and/or publish the UCF to a selected group or all of the users of the platform 100 or a network via button 810.

In one example of an operation using the GUI screen 800, a user may select the button 804, which provides a second pop-up GUI screen 816 (FIG. 8A-2). The GUI screen 816, in turn, allows a user to modify or edit the various characteristics and/or relationships of the selected interface element. For instance, the general characteristics of the UCF, such as associated data tables, types, names, display texts etc. may be modified in the design area 820 on the left panel of the GUI screen 816. It will be appreciated that the fields provided in the design area 820 are a function of individual UCFs, and as such, may vary according to the particular characteristics of the selected UCFs, which are defined when the element is created. Similarly, in the design area 818 of the right panel of the GUI screen 816, the data fields may be modified. Although not shown in the interest of brevity, the individual data fields may be selected and one or more pop-up screens provided to handle the specific modifications of the data fields in the design area 818. A field 819 within the design area 818 may be selected, as shown in FIG. 8A-3, to implement the delete and edit capabilities of the UCF Manager.

As further illustrated in FIG. 8A-2, the GUI screen 816 allows users to add new data fields to an existing UCF using button 822. Furthermore, additional functionality may be provided such as allowing a user to define/change a status for the UCF, e.g., active versus inactive. Finally, the user may be provided with the ability to define a status of the individual data fields within the UCF. Advantageously, this feature may be utilized to increase the flexibility of a UCF by permitting users to select and deselect desired data fields to be utilized during a data acquisition event. In other words, a user may reconfigure UCF to accommodate different data acquisition events through selection and deselection of desired data fields to be included in the UCF, as well as redefine the status of the individual data fields within the UCF. Thus, FIGS. 8A-1 through 8A-3 show interfaces for enabling user configurable fields.

FIGS. 8B-1 through 8B-7 illustrate interfaces for enabling User Configurable Rules or requirements (“UCRs”). In particular, FIG. 8B-1 illustrates a screen 824 that is displayed within a UCR Manager. In particular, this screen depicts the UCR Manager in a state before a UCR has been defined. Upon selection of an appropriate rules editor graphical interface element, an action definition pop-up window 830 (FIG. 8B-2) is provided. In this window 830, the user can select from a list (832) of available action types (in this case, adding a user configurable field for a pesticide), enter (834) a name for the action with a relevant action module, select (838) an action type category (in this case, user configurable fields), designate (840) the action command and enter (842) a prompt to build the command.

After defining a new action, the action may be associated with other actions using an “associate actions” screen 844 as shown in FIG. 8B-3. In this case, the defined action is associated with the UCF “Require on Pesticide Case.” After thus associating an action with a UCR, a UCR Manager screen 845 (FIG. 8G) shows the newly associated UCF action with the associated UCR.

FIGS. 8B-5 through 8B-7 illustrate the process by which rules are defined using the UCR Manager. FIG. 8B-5 shows a screen 846 by which a user can define the rules that the UCR tests for to determine if the associated action is to be taken. To define the UCR's criteria, the user can select the Advanced Query Builder screen 847 (FIG. 8B-6) to define the rules. In this case, the “Environment: Pesticides” CallType is selected as the rule to be tested for during case entry. FIG. 8B-7 shows a UCR Manager screen 848 after the rules have been defined in the Advanced Query Builder. It is at this point that the UCR is saved and its metadata is released to the rest of the system so that it can become active.

FIGS. 8C-1-8C-2 illustrate an example of how a UCF and a UCR might be utilized in connection with a case screen 850 filled out in connection with fielding a call at a poison control center of similar facility. As shown in FIG. 8C-1, the call type field 852 has been selected. This selection matches the defined UCR rule and the UCR has executed the associated action. The result is that the UCF Field 854 has become highlighted indicating that a UCF has been added to the case. FIG. 8C-2 shows the “PestExposure” UCF window 856 brought to the screen 850 for data entry when the user selected it from the UCF Field 854 in the screen 850.

It will be appreciated that many different types of actions may be associated with a UCR. FIG. 8D shows a window 858 that may be displayed in connection with a “Message” type of action. In this case, the user is reminded to ask specified questions in connection with an associated CallType or other associated criterion. FIG. 8E shows a case screen 860 depicting the result of a DDR executing several Required Fields types of actions, i.e., indicating fields that are required to be entered for a particular call type according to a DDR.

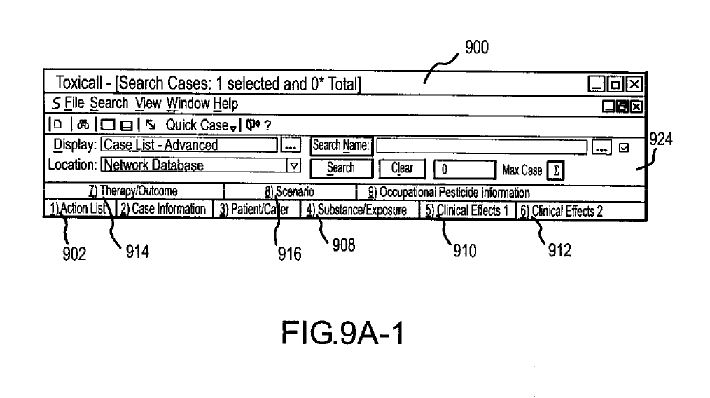

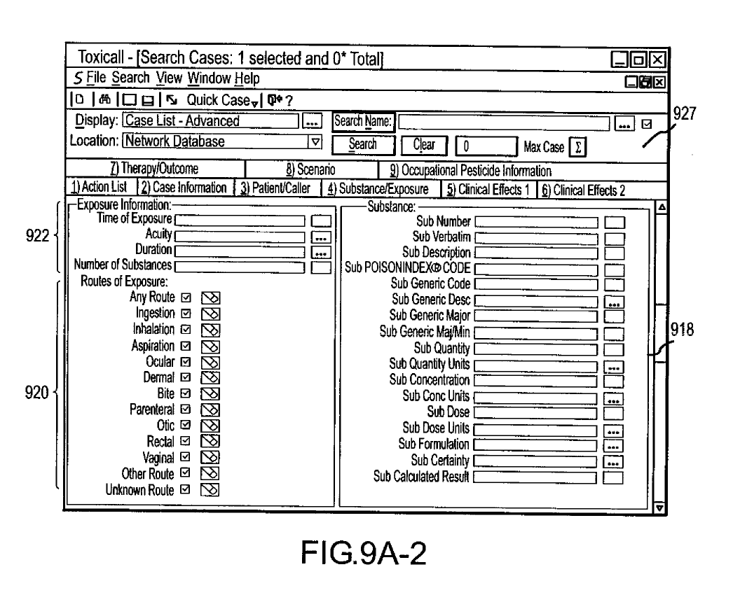

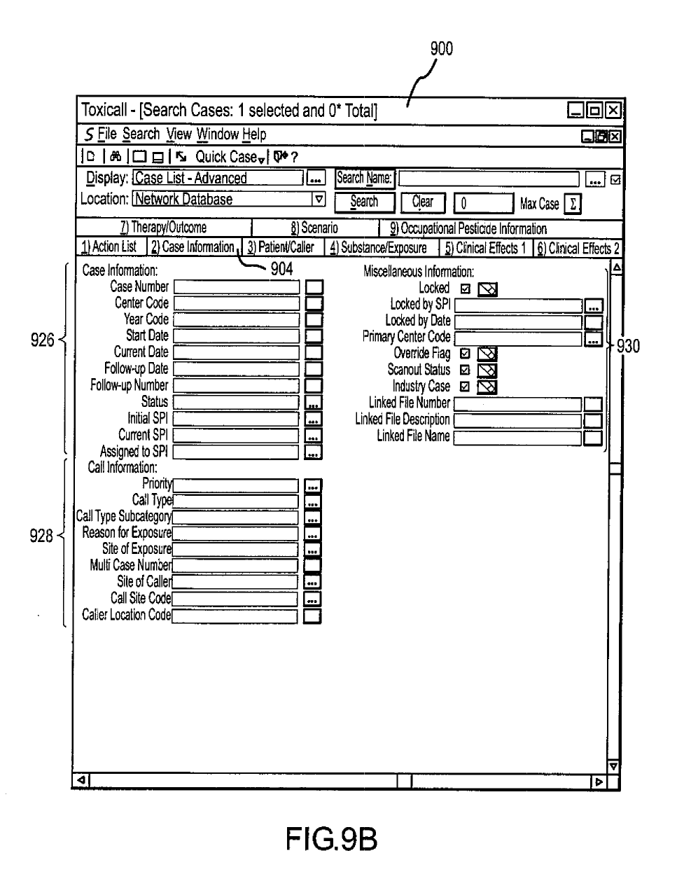

Referring to FIGS. 9A-1-9A-2, an example of a GUI screen 900 (only the upper portion thereof is shown in FIG. 9A-1) is provided to illustrate functionality associated with searching and reporting of data. In particular, according to this example the GUI 900 may provide an area 924 for entry of and/or definition of general search/report criteria such as a name, a data location, a desired number of results, etc. The GUI 900 further provides a plurality of tabs 902-916 that may be selected for entry of search and report criteria. According to this example, each tab 902-916 may represent a broad category of search criteria such that, upon selection of any one of the tabs 902-916, a user is further presented with a GUI screen for definition of specific search criteria. For instance, as illustrated in FIG. 9A-1, upon selection of the Substance/Exposure tab 908, the user is presented with a list 918 of user enterable search criteria related to a substance. Similarly, the search report criteria may be further narrowed by selecting one or more exposure routes from a list 920 or definition of one or more aspects of exposure information in a list 922. Similarly, where the case information tab 904 is selected (FIG. 9B), the user may be presented with a list 926 for entry of search criteria related to case information, a list 928 related to call information, and/or a list 930 related to miscellaneous information.

It will be appreciated that the GUI screens above are provided to illustrate the above set forth principles and operational protocols at the user lever. Thus, it will be appreciated by those skilled in the art that various other GUI screens, not illustrated in the interest of brevity, will be utilized in carrying out the present principles and protocols of the present invention.

The above-described elements can be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. The term “processor” refers to a single processing device or a group of inter-operational processing devices. Some examples of processors are integrated circuits and logic circuitry. Those skilled in the art are familiar with instructions, processors, and storage media.

The discussion above has demonstrated the ability to dynamically define: 1) additional fields that need to be captured (via UCF/DDF); 2) conditions under which those fields will be requested (UCR/DDR); and 3) search and reporting criteria. Collectively, these capabilities provide considerable flexibility in organizing a database, accessing a database and controlling system interactions involving the database. It has been recognized that these capabilities can be utilized to enable multiple levels of secure access to a database.

In particular, the noted capabilities can be utilized to dynamically secure access to any database field, including the dynamically defined fields from within the application, thereby restricting access based on a content parameter, e.g., columns of a database table. In addition, the noted capabilities allow for dynamically specifying security restrictions based on field values and complex field value relationships/conditions, e.g., restricting access based on a second data parameter, for example, corresponding to rows of a database table. In this manner, a single database may be utilized and the associated applications can restrict users based on their individual security rights to certain rows and columns of information.

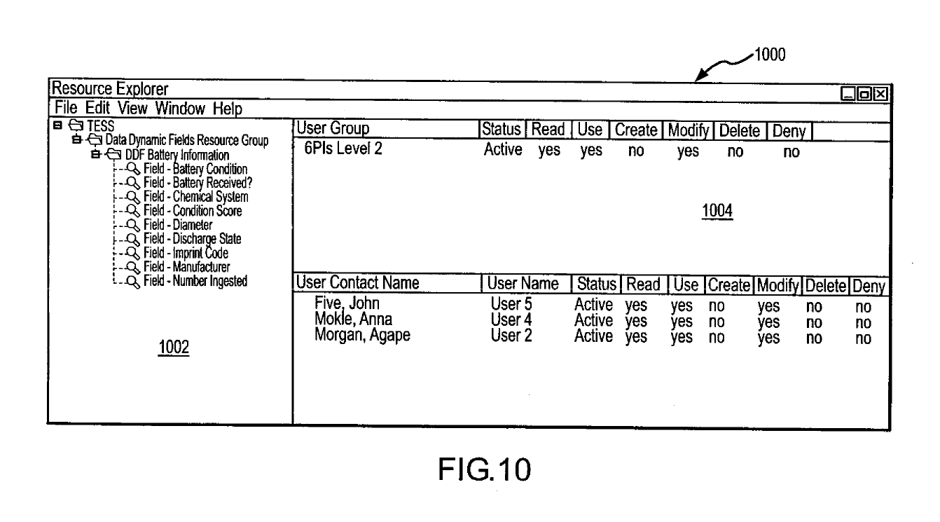

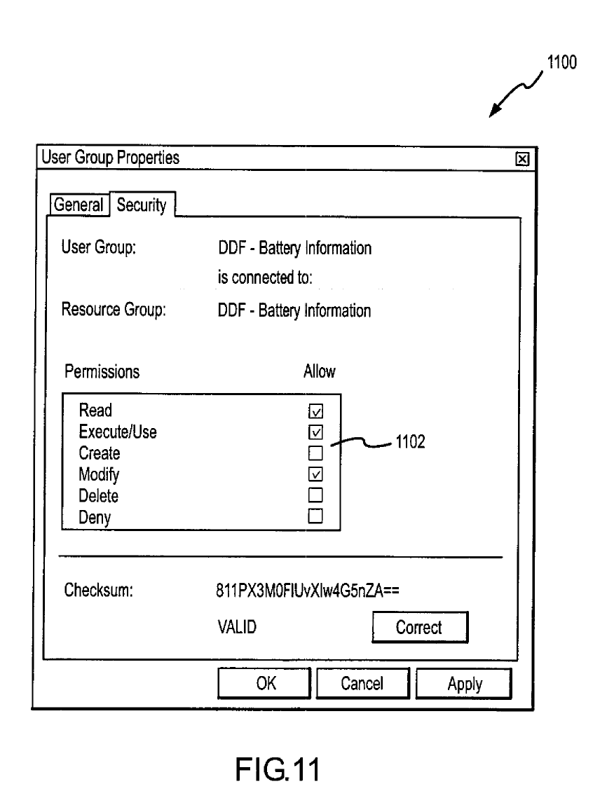

The process and associated structure for restricting access based on data fields including dynamically defined fields may be understood by reference to the screen shots of FIGS. 10 and 11. In particular, after defining a UCF/DDF or UCF/DDF field, the screen of FIG. 10 can be invoked by selecting a “custom security” interface element, e.g., a button, selection from a pull down menu or the like. The screen 1000 allows the user to secure the new UCF/DDF. In the left panel 1002 a resource group hierarchy is shown. In this case, the resource group “DDF/Battery Information” has been selected. It will be appreciated that a user could instead choose to secure individual fields separately, for example, “Field-Manufacturer.” As shown, “DDF-Battery Information” belongs to the “Data Dynamic Fields resource group,” which in turn belongs to the “TESS” resource group. It will be appreciated that significant flexibility is allowed in defining a hierarchy in this regard.

In panel 1004 the user has selected the “SPIs Level 2” user group to have access to the “DDF Battery Information” data. As shown, the user can further identify the specific kinds of database interactions that are allowed. In this case, the user group “SPIs Level 2” has been allowed access to DDF Battery Information for the interactions “Read,” “Use,” and “Modify.” This group has been denied access for the interactions denoted “Create,” “Delete,” and “Deny.” The “Read” interaction indicates that the user may view the field's contents on screens and in reports. This does not allow the user to change the field value. The “Modify” interaction, assuming that users have “Read” access, allows the user to change the contents of the field in any screen. The “Use” interaction indicates that the user may use the field to specify search and reporting criteria for many of the dynamically created criteria screens. The user need not have “Read” or “Modify” access to use the field when specifying criteria. The user would need “Read” access to be able to view the value of the same field in an output report, for example. The “Create” interaction allows the user to create the field's contents and, conversely, the “Delete” interaction allows the user to delete the field's contents. The “Deny” interaction indicates a field that may be explicitly denied access. This might be used to deny one field while still allowing access to other fields at a group level.

Panel 1006 identifies the users that are included in the user group “SPIs Level 2.” As shown, access rights are defined for each individual user with respect to each of the interaction types. In this case, the rights were defined on a user group level and are the same for each user. However, it is possible to define different access rights on an individual basis even within a given user group.

FIG. 11 illustrates a screen shot 1100 for use in specifying access rights. For example, the screen 1100 may be accessed by way of an appropriate interface element such as a button or selection from a pull down screen. As shown, a panel 1102 can be used to selectively allow or disallow any of the noted interaction types. It will be appreciated that this panel will generally be specific to a particular user or user group and a particular resource or resource group. In the illustrated example, “Read,” “Modify,” and “Use” rights are being granted for the Battery Information DDF, and hence all the fields in that DDF.

Security restrictions on fields apply to: 1) the fields a user may view on screens, in reports and as search results from any query, including user created queries; 2) the fields a user may edit on any screen; 3) the fields a user may use as search or reporting criteria; and 4) the fields that are explicitly denied any access. When a field is defined in UCF/DDF, users will have the option to accept a default security (as set in associated preferences), or apply custom security. Default security grants default access (as defined in preferences) to a default user group (also defined in preferences). Custom security allows the user to specify which user groups will have access to the new field and the level of access.

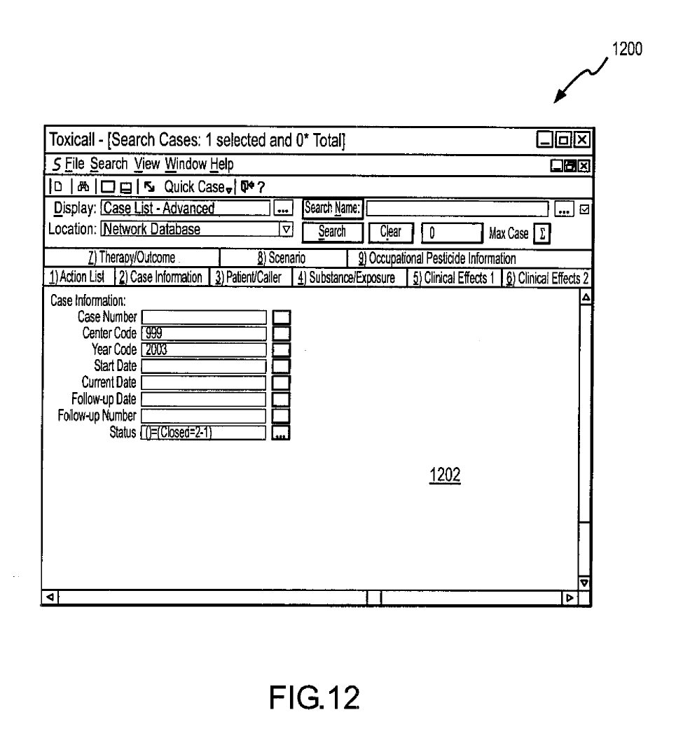

Thus, in a manner similar to the way that search and reporting criteria can be dynamically defined using a metadata model is described above, security restrictions can be defined. Once defined, a user can access a screen 1200, as shown in FIG. 12, and see the possible criteria by which a user's access may be restricted. The user may specify field values and conditions that will restrict user access to data matching those values and conditions. In the illustrated example, the fields in the case information panel 1202 are created dynamically from metadata. In this example, the application will restrict access so that the specified users will only be able to see cases from a poison control center indicated by the center code “999” that were created in year 2003 and that are now “closed.”

Similarly, a supervisor user may enter conditions and values for example:

[ToxPat]Patient Age<21 and [ToxPat] Age Units=‘Years’

Once this information is saved, the restricted user will only be able to see data that matches the criteria specified. In a similar manner, access can be restricted to information relating to a specific field or any other field in the database.

Again, users will have the option of accepting default security (as set in preferences), for applying custom security. Default security grants default access (as defined in preferences) to a default user group (also defined in preferences). Custom security allows the user to specify which user groups will have access to the data and the level of access.

While various embodiments of the present invention have been described in detail, it is apparent that further modifications and adaptations of the invention will occur to those skilled in the art. However, it is to be expressly understood that such modifications and adaptations are within the spirit and scope of the present invention.

We claim:

1. A method for use in capturing patient data comprising the steps of:
in a medical data acquisition processing platform having a plurality of defined interface elements for acquiring medical data relating to one or more medical events, each of the defined interface elements providing one of data entry and selection options relative to medical data for one of the medical events;
providing a first interface to permit a first user to define a new interface element different than the plurality of defined interface elements, wherein the new interface element relates to a subject medical event not included in the one or more medical events;
defining in the first interface one of data entry and selection options related to the subject medical event;
making the new interface element available to a second user of the processing platform;
receiving in the processing platform data entered by the second user using the new interface element; and
processing the data using a processor associated with the processing platform to obtain information related to the subject medial event.

2. The method of claim 1, wherein the providing step comprises:
establishing the first interface using a metadata model involving code, programmed into said platform, having a number of data objects that can be configured to assume desired attributes such that said first interface can be configured to have data entry and selection options desired by the first user.

3. The method of claim 1, the method comprising:
in the processing platform, implementing a plurality of defined rules for controlling one of the receipt of data in the plurality of defined interface elements and the new interface element.

4. The method of claim 3, the method comprising:
defining in the first interface a plurality of new interface elements different than the plurality of defined interface elements, wherein the plurality of new interface elements relate to a plurality of subject medical events not addressed by the defined interface elements.

5. The method of claim 4, the wherein the providing step comprises:
providing a second interface to permit the first user to define new rules different than the plurality of defined rules for controlling the receipt of data in one of the plurality of defined interface elements and the plurality of new interface elements; and
establishing the second interface using a second metadata model involving code, programmed into said platform, having a second number of data objects that can be configured to assume desired attributes such that said second configurable interface can be configured to define new rules.

6. The method of claim 5, the method comprising:
in the second configurable interface associating the new rules with desired ones of the plurality of defined interface elements and the plurality of new interface elements, wherein the new rules are applied to the associated plurality of defined interface elements and the plurality of new interface elements.

7. The method of claim 4, the method comprising:
providing a third interface to permit the first user to define searching parameters for searching the plurality of defined interface elements and the plurality of new interface elements; and
establishing the third interface using a third metadata model involving code, programmed into said platform, having a third number of data objects that can be configured to assume desired attributes to define the searching parameters.

8. The method of claim 4, the method comprising:
providing a fourth interface to permit the first user to define reporting parameters for reporting data collected using the plurality of defined fixed interface elements and the plurality of new dynamic interface elements; and
establishing the fourth interface using a fourth metadata model involving code, programmed into said platform, having a fourth number of data objects that can be configured to assume desired attributes to define the reporting parameters.

9. A method for use in capturing patient data comprising the steps of:
in a platform for acquiring medical information, said platform implementing a plurality of defined rules to control receipt of data in a plurality of defined interface elements for acquiring medical data relating to one or more medical events, each of the plurality of interface elements providing one of data entry and selection options relative to medical data for one of the medical events;
providing a first interface to permit a first user to define new rules different than the plurality of defined rules to control receipt of data in the plurality of interface elements
defining in the first interface, the new rules;
associating the new rules with a desired group of the plurality of defined interface elements; and
during receipt of data using one of the plurality of defined interface elements belonging to the desired group, applying the new rules to control the receipt of the data.

10. The method of claim 9, wherein the providing step comprises:
establishing the first interface using a metadata model involving code, programmed into said platform, having a number of data objects that can be configured to assume desired attributes such that said first configurable interface can be configured to define the new rules.

11. The method of claim 9, the method comprising:
providing a second interface to permit the first user to define a new interface element different than the plurality of defined interface elements; and
establishing the second configurable interface using a second metadata model involving code, programmed into said platform, having a second number of data objects that can be configured to assume desired attributes to define the new interface elements.

12. The method of claim 11, the method comprising:
wherein at least a portion of the new rules apply to the new interface element and during receipt of data using the new interface element, applying the portion of the new rules to control the receipt of the data.

13. The method of claim 11, the method comprising:
providing a third interface to permit the first user to define searching parameters for searching the plurality of defined interface elements and the new interface element; and
establishing the third interface using a third metadata model involving code, programmed into said platform, having a third number of data objects that can be configured to assume desired attributes to define the searching parameters.

14. The method of claim 13, the method comprising:
wherein at least a portion of the new rules apply to the searching parameters and during a search using the searching parameters applying the portion of the new rules to control the search.

15. The method of claim 11, the method comprising:
providing a fourth interface to permit the first user to define reporting parameters for reporting data collected using the plurality of defined interface elements and the new interface elements; and
establishing the fourth interface using a fourth metadata model involving code, programmed into said platform, having a fourth number of data objects that can be configured to assume desired attributes to define the reporting parameters.

16. The method of claim 15, the method comprising:
wherein at least a portion of the new rules apply to the reporting parameters and during a reporting event using the reporting parameters applying the portion of the new rules to control the reporting event.

17. A method for use in searching patient data comprising the steps of:
in a medical data acquisition processing platform having a plurality of defined interface elements for acquiring medical data relating to one or more medical events, each of the defined interface elements providing one of data entry and selection options relative to medical data for one of the medical events;
providing a first interface to permit a user to define a new interface element different than the plurality of defined interface elements, wherein the new interface element relates to a subject medical event not included in the one or more medical events;
searching the plurality of defined interface elements and the new interface element using a metadata model involving code, programmed into said platform, having a number of data objects configured to assume desired searching parameters defined by the user.

18. A method for use in capturing patient data comprising the steps of:
in a medical data acquisition processing platform having a plurality of defined interface elements for acquiring medical data relating to one or more medical events, each of the defined interface elements providing one of data entry and selection options relative to medical data for one of the medical events;
providing a first interface to permit a first user to define a new interface element different than the plurality of defined interface elements, wherein the new interface element relates to a subject medical event not included in the one or more medical events;
establishing the first interface using a metadata model involving code, programmed into said platform, having a number of data objects that can be configured to assume desired attributes such that said first configurable interface can be configured to have data entry and selection options desired by the first user.
defining in the interface one of data entry and selection options related to the subject medical event;
making the new interface element available over the network to a second user of the processing platform;
receiving in the processing platform data entered by the second user using the new interface element; and
processing the data using a processor associated with the processing platform to obtain information related to the subject medial event.

19. A software product for use in operating a medical data acquisition processing platform having a plurality of defined interface elements for acquiring medical data relating to one or more medical events, each of the defined interface elements providing one of data entry and selection options relative to medical data for one of the medical events, the product comprising:
processing system instructions operational when executed by a processing system to direct a processor to provide over a network, a first interface, the first interface permitting a first user to define a new interface element different than the plurality of defined interface elements, wherein the new interface element relates to a subject medical event not included in the one or more medical events, and to direct the processor to make the new interface element available over the network to a second user of the processing platform and to direct the processor to process data entered by the second user using the new interface element to obtain information related to the subject medial event.
interface system instructions operational when executed by the processing system to direct an interface system to receive the data entered by the second user using the new interface element; and
a storage medium operational to store the processing system instructions and the interface system instructions.

20. A medical data acquisition processing platform having a plurality of defined interface elements for acquiring medical data relating to one or more medical events, each of the defined interface elements providing one of data entry and selection options relative to medical data for one of the medical events, the platform comprising:
at least one processor configured to provide over a network, a first interface to permit a first user to define a new interface element different than the plurality of defined interface elements, wherein the new interface element relates to a subject medical event not included in the one or more medical events, wherein the processor is further configured to make the new interface element available over the network to a second user of the processing platform and process the data by the second user using the new interface element to obtain information related to the subject medical event; and
an interface system operational to receive data entered by the second user using the new interface element for the processor.

21. A method for providing multiple levels of secure access to data, comprising the steps of:
establishing a database including multiple data entries indexed by at least first and second data parameters such that a set of said data parameters collectively identifies a particular one of said multiple data entries;
providing a security module for limiting system interaction involving said database on a user dependent basis;
first operating said security module to define a first access level for a first user based on an identity of said first user and at least one of said first and second data parameters;
second operating said security module to define a second access level for a second user based on an identity of said second user and at least one of said first and second data parameters;
first controlling a first system interaction by said first user in accordance with said first access level; and
second controlling a second system interaction by said second user in accordance with said second access level.

22. A method as set forth in claim 21, wherein said first parameter any of multiple categories of data and said second parameter identifies an instance of data within one of said categories.

23. A method as set forth in claim 21, wherein said database is managed by an application running on a platform, and said step of establishing comprises defining at least one of said parameters after deployment of said application on said platform.

24. A method as set forth in claim 21, wherein said security module is operative for limiting access to said database such that an identified user can access only a portion les than the whole of said database.

25. A method as set forth in claim 21, wherein said security module is operative to limit the types of interaction with said database such that an identified user is enabled to perform only particular interactions of a set of possible interactions less than the whole of said set.

26. A method as set forth in claim 21, wherein said security action is operative to limit the types of interaction with the database dependent on one or more of the data parameters such that an identified user is enabled to perform only particular interactions of a set of possible interactions, less than the whole of said set, with regard to a portion less than the whole of said database identified by said one or more of the data parameters.

27. A method as set forth in claim 26, wherein said portion of said database is identified by a combination of said first and second parameters.

28. A method as set forth in claim 21, wherein said step of first operating comprises controlling a computer system to identify said first user, identify a portion less than the whole of said database associated with one or more of said parameters, and selectively enabling or disabling at least one interaction of a set of possible interactions for said first user in connection with said portion of the database.

29. A method as set forth in claim 21, wherein said step of first controlling comprises receiving an interaction request identifying said first user and requesting interaction with a portion of said database identified by at least one of said parameters, performing a comparison of said interaction request to said first access level and selectively responding to said request based on said comparison.

30. A method as set forth in claim 29, wherein said selectively responding comprises enabling interaction with respect to a subset of data corresponding to less than the whole of said requested portion.

31. A method as set forth in claim 29, wherein said selectively responding comprises enabling only particular interactions less than the whole of a set of possible interactions with regard to said portion of said database.

32. A method as set forth in claim 29, wherein said selectively responding comprises denying said interaction request.
